(19) United States
(12) Patent Application Publication
(10) Pub. No.: US 2009/0224722 A1
(43) Pub. Date: Sep. 10, 2009

(54) Purse Having A Power Recharger Built Therein

(76) Inventor: Steve Causey, Douglasville, GA (US)

Correspondence Address: PAUL R. MARTIN, 5333 BAYRIDGE COURT, FAIRFIELD, CA, 94534, US

(21) Appl. No.: 12/043,217

(22) Filed: Mar. 6, 2008

(51) Int. Cl. H02J 7/00

(52) U.S. Cl. 320/101

(57) ABSTRACT

A solar-powered battery charger is incorporated into a purse with the solar cells being located in the strap of the purse and a charger cord being electrically connected to the solar cells and located to attach to an item to be charged which is located inside the purse.

### TECHNICAL FIELD OF THE INVENTION

The present invention relates to the general art of battery chargers, and to the particular field of battery chargers that can be used in conjunction with cellular telephones.

### BACKGROUND OF THE INVENTION

A battery charger is a device used to put energy into a cell or (rechargeable) battery by forcing an electric current through it. The charge current depends upon the technology and capacity of the battery being charged. For example, the current that should be applied to recharge a 12 V car battery will be very different to the current for a mobile phone battery.

A simple charger works by connecting a constant DC power source to the battery being charged. The simple charger does not alter its output based on time or the charge on the battery. This simplicity means that a simple charger is inexpensive, but there is a tradeoff in quality. Typically, a simple charger takes longer to charge a battery to prevent severe over-charging. Even so, a battery left in a simple charger for too long will be weakened or destroyed due to over-charging.

The output of a timer charger is terminated after a pre-determined time. Timer chargers were the most common type for high-capacity Ni—Cd cells in the late 1990s for example (low-capacity consumer Ni—Cd cells were typically charged with a simple charger).

Often a timer charger and set of batteries could be bought as a bundle and the charger time was set to suit those batteries. If batteries of lower capacity were charged then they would be overcharged, and if batteries of higher capacity were charged they would be only partly charged. With the trend for battery technology to increase capacity year on year, an old timer charger would only partly charge the newer batteries.

Timer based chargers also had the drawback that charging batteries that were not fully discharged, even if those batteries were of the correct capacity for the particular timed charger, would result in over-charging.

Output current depends upon the battery's state. An intelligent charger may monitor the battery's voltage, temperature and/or time under charge to determine the optimum charge current at that instant. Charging is terminated when a combination of the voltage, temperature and/or time indicates that the battery is fully charged.

For Ni—Cd and NiMH batteries, the voltage over the battery increases slowly during the charging process, until the battery is fully charged. After that, the voltage decreases, this indicates to an intelligent charger that the battery is fully charged. Such chargers are often labeled as a ΔV charger, indicating that they monitor the voltage change.

Fast chargers make use of control circuitry in the batteries being charged to rapidly charge the batteries without damaging the cells' elements. Most such chargers have a cooling fan to help keep the temperature of the cells under control. Most are also capable of acting as a standard overnight charger if used with standard NiMH cells that do not have the special control circuitry. Some fast chargers, such as those made by Energizer, can fast-charge any NiMH battery even if it does not have the control circuit.

Some chargers use Pulse technology in which a pulse is fed to the battery. This DC pulse has a strictly controlled rise time, shape, pulse width, frequency and amplitude. This technology is said to work with any size, voltage, capacity or chemistry of batteries, including automotive and valve-regulated batteries.

Since the Universal Serial Bus specification provides for a five-volt power supply, it's possible to use a USB cable as a power source for recharging batteries. Products based on this approach include chargers designed to charge standard NiMH cells, and custom NiMH batteries with built-in USB plugs and circuitry which eliminate the need for a separate charger. Since a battery charger is intended to be connected to a battery, it may not have voltage regulation or filtering of the DC voltage output. Battery chargers equipped with both voltage regulation and filtering may be identified as battery eliminators.

Most mobile phone chargers are not really chargers, only power sources for the charging circuitry which is almost always contained within the mobile phone. Mobile phones can usually accept relatively wide range of voltages, as long as it is sufficiently above the phone battery's voltage.

However, it the voltage is too high, it can damage the phone. Mostly, the voltage is 5 volts or slightly higher, but it can sometimes vary up to 12 volts when the power source is not loaded.

Battery chargers for mobile phones and other devices are notable in that they come in a wide variety of connector-styles and voltages, most of which are not compatible with other manufactuers' phones or even different models of phones from a single manufacturer.

Users of publicly accessible charging kiosks must be able to cross-reference connectors with device brands/models and individual charge parameters and thus ensure delivery of the correct charge for their mobile device. A database-driven system is one solution, and is being incorporated into some of the latest designs of charging kiosks.

A travel charger from Ionhub is a portable charging hub. It is more of a universal charger because it can simultaneously charge many different electronic devices. There are also human-powered chargers sold on the market, which typically consists of a dynamo powered by a hand crank and extension cords. There are also solar chargers.

A mobile telephone or cellular telephone (commonly “mobile phone” or “cell phone”) is a long-range, portable electronic device used for mobile communication. In addition to the standard voice function of a telephone, current mobile phones can support many additional services such as SMS for text messaging, email, packet switching for access to the Internet, and MMS for sending and receiving photos and video. Most current mobile phones connect to a cellular network of base stations (cell sites), which is in turn interconnected to the public switched telephone network (PSTN) (the exception is satellite phones).

Mobile communication has been playing an important role in the rapidly developed technological fields. Consumers place more reliance on mobile phones than ever. The mobile phone is characterized in the convenience it provides in electronic communication, and it enables a user to keep contact with others at any place and at any time. The mobile phone obtains its operating power from a battery that might run out of power and requires recharging through a charger. However, an outlet for an adapter of the charger to plug is not always available at any place, and a user would usually not carry an additional battery or batteries along with the mobile phone. When the mobile phone is battery low, particularly when it is used outdoors, the user could not help but watching the mobile phone to shut down automatically.

To solve the above problem, there is developed an emergency charger for a mobile phone user to charge a mobile phone battery with a general dry cell. A spare auxiliary battery is often used by the user to replace the original cellular phone battery in the event of battery discharge or failure. If the auxiliary battery is not available, the cellular phone with the discharged battery must be recharged with an exterior charger or hands-free vehicle kit charger.

In order to continuously use a cellular phone, a user should keep a charged auxiliary battery at all times for the cellular phone. However, there is a tendency to only use the battery integral with the cellular phone because it causes user inconvenience to carry an additional auxiliary battery. Further, to carry the auxiliary battery may cause an unintentional short circuit of the recharging terminal of the auxiliary battery, resulting in discharge.

Limited use of the charger according to the place in recharging the cellular phone battery often brings about the battery discharge. Otherwise, the cellular phone should be in a standby state until the charger completes recharging operation.

Since a conventional charger generally utilizes an alternative current source, 110V˜V220V, designed for indoor or public use, it becomes difficult to recharge the battery at the outdoor place without an alternating current source. In a vehicle, power of 12˜24V direct current is utilized to recharge the battery, but this often necessitates ignition of the vehicle and maintaining the charger and cellular phone inside the car.

A laptop computer, or simply laptop (also notebook computer or notebook), is a small mobile computer, which usually weighs 2-18 pounds (1-6 kilograms), depending on size, materials, and other factors. Laptops usually run on a single main battery or from an external AC/DC adapter which can charge the battery while also supplying power to the computer itself. Many computers also have a 3 volt cell to run the clock and other processes in the event of a power failure.

As personal computers, laptops are capable of the same tasks as a desktop computer, although they are typically less powerful for the same price. They contain components that are similar to their desktop counterparts and perform the same functions, but are miniaturized and optimized for mobile use and efficient power consumption. Laptops usually have liquid crystal displays and most of them use different memory modules for their random access memory (RAM), for instance, SO-DIMM in lieu of the larger DIMMs. In addition to a built-in keyboard, they may utilize a touchpad (also known as a trackpad) or a pointing stick for input, though an external keyboard or mouse can usually be attached.

There is a need for a means to allow a user to keep a trickle charge on a mobile phone or a camera while wearing a purse, camera bag, or laptop bag.

### SUMMARY OF THE INVENTION

These, and other, objects, are achieved by a solar-powered battery charger that is incorporated into a purse with the solar cells being located in the strap of the purse and a charger cord being electrically connected to the solar cells and located to attach to an item to be charged which is located inside the purse.

The system embodying the principles of the present invention will allow a user to keep a trickle charge on a mobile phone or a camera while wearing a purse, camera bag, or laptop bag. The system incorporates 10.5 volt flexible solar cells that have a zener voltage regulator built into a strap of a camera bag, purse, or laptop bag. The flexible solar cells would likely be sewn or molded into the strap, and conduct electronic circuitry that would trickle charge a mobile phone, camera or laptop computer while a camera bag, purse, or laptop bag is being worn by a user.

The system of the present invention will allow a user to keep a small charge on a mobile phone so that it won't lose power as quickly. It also could possibly make a phone or camera eventually useable if they are damaged.

### BRIEF DESCRIPTION OF THE DRAWINGS FIGURES

FIG. 1 is a perspective view of a purse embodying the principles of the present invention.

FIG. 2 is a schematic showing a connection for connecting the solar charger located in the strap of the container to an appliance to be charged.

FIG. 3A is a schematic showing a circuit for use in conjunction with four to six volt devices.

FIG. 3B is a schematic showing a connector for connecting an electrical appliance to the circuit shown in FIG. 3A.

FIG. 4A is a schematic showing a circuit for use in conjunction with nine to twelve volt devices.

FIG. 4B is a schematic showing a Zener diode used in the connector for connecting an electrical appliance to the circuit shown in FIG. 4A.

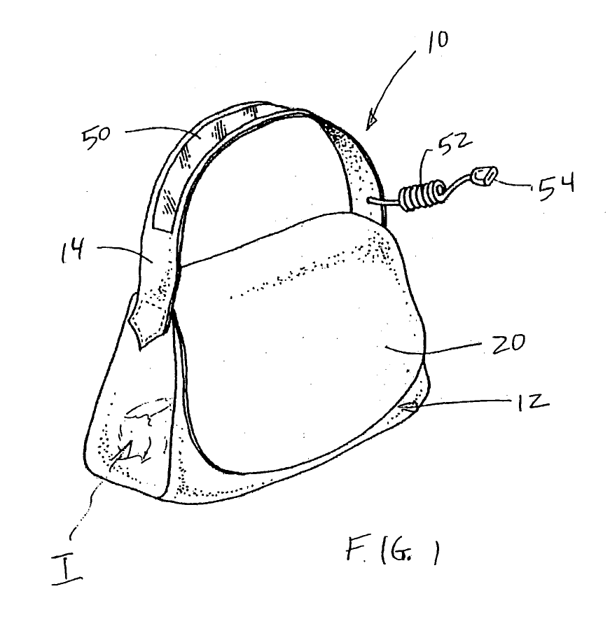

### DETAILED DESCRIPTION OF THE PREFERRED EMBODIMENT OF THE INVENTION

Other objects, features and advantages of the invention will become apparent from a consideration of the following detailed description and the accompanying drawings.

Referring to the figures, it can be understood that the principles of present invention are embodied in a container, such as purse 10, having a body 12 in which items I, such as a cellular telephone, a camera, a computer, or the like are stored and a strap 14 attached to the body to support that body. A flap 20 is flexibly attached to the body to cover and uncover an opening (not shown) in the body as is customary for purses and pouches. The items stored in the container include rechargeable batteries

Strap 14 includes a first surface 30 which is a top surface when the strap is in use and a second surface 32 which is a bottom surface when the strap is in use as shown in the figure. Strap 14 further includes a first end 36 fixedly attached to body 12, a second end 38 fixedly attached to body 12 and a longitudinal axis 40 which extends between ends 36 and 38.

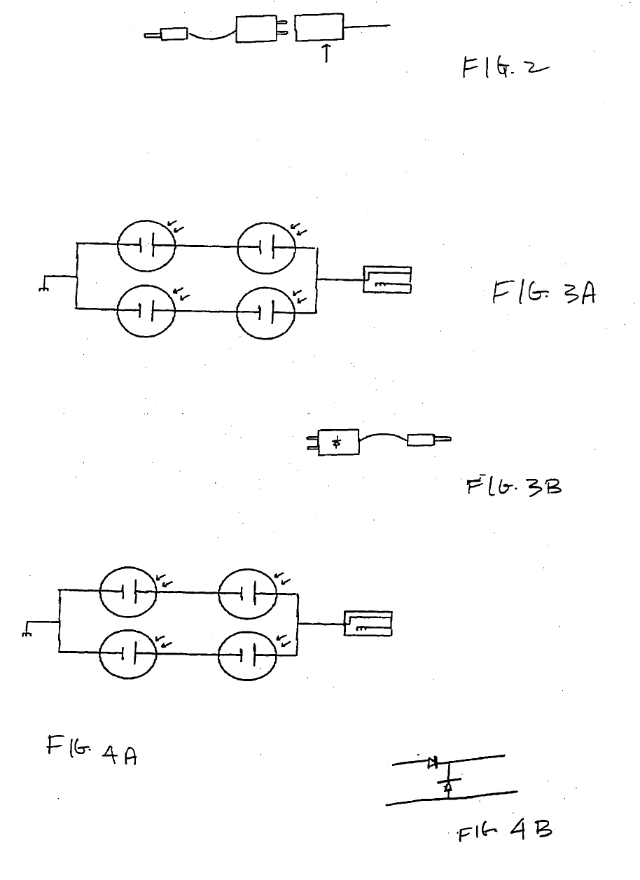

A solar collector array 50 is located on top surface 30 in position to collect solar rays when the purse is in use. The details of the solar collector array are known to those skilled in the art and thus will not be discussed or claimed. Solar array 50 is electrically connected to a charger plug lead 52 using electrical connections known to those skilled in the art. A charger plug 54 is electrically connected to lead 52. The electrically connections are shown in FIGS. 3A through 4B and include Zener diodes to prevent overcharging; and are otherwise known in the art and the particular connections do not form part of this invention. As such, the particular electrical connections used to connect the solar array to the plug will not be disclosed or claimed.

An electronic device, such as a cellular telephone or the like, can be stored and carried in the purse and can be charged while it is being so carried by being connected to the solar array via plug 52. As such, the device will always be charged and ready for use.

While one form of the system has been disclosed, the inventor also contemplates the following alternative forms as well: the system can Incorporate a universal keyed connection into Purse/Camera Strap Trickle Charger For Phones, Cameras Etc. which will allow multiple bands, voltages, and models of mobile phones, cameras, and laptop computers; and the system can incorporate an additional type of connector that can be used to charge other things besides cameras, laptop computers, and mobile phones.

It is understood that while certain forms of the present invention have been illustrated and described herein, it is not to be limited to the specific forms or arrangements of parts described and shown.

What is claimed is:

1. A charging system for electrical devices such as cellular telephones, cameras and the like comprising:
A) a container for storing an electrical device such as a cellular telephone, a camera or the like, the container including a body which defines a storage compartment in which the electrical device is stored, the body;
B) a strap on the container for supporting the container;
C) an electrical system for charging a battery in the electrical device stored in the body, the electrical system including
(1) a solar cell collector system in the strap,
(2) an electrical circuit for converting solar power from the solar cell collector system into electrical voltage which is suitable for use in charging the electrical device; and
(3) an electrical connector electrically connecting the electrical circuit to the electrical device when the electrical device is located in the container whereby the solar cell collector system located in the strap is used to charge the electrical device when the electrical device is stored in the container.

2. The charging system defined in claim 1 in which the container is a purse.
